(19) United States
(12) Patent Application Publication
(10) Pub. No.: US 2014/0341076 A1
(43) Pub. Date: Nov. 20, 2014

(54) ACCESS NETWORK DISCOVERY AND SELECTION

(71) Applicant: ALCATEL LUCENT, Paris (FR)

(72) Inventors: Barbara Orlandi, Nozay (FR); Laurent Thiebaut, Nozay (FR); Jean-Luc Lafragette, Nozay (FR)

(73) Assignee: ALCATEL LUCENT, Boulogne Billancourt (FR)

(21) Appl. No.: 14/363,053

(22) PCT Filed: Dec. 4, 2012
(86) PCT No.: PCT/EP2012/074359

§ 371 Date: Jun. 5, 2014

(30) Foreign Application Priority Data
Dec. 5, 2011 (EP) 11306614.6

(51) Int. Cl. H04W 48/16; H04W 36/00

(52) U.S. Cl. CPC H04W 48/16; H04W 36/0066
USPC 370/254

(57) ABSTRACT

Communication process within a network such as a Wi-Fi network, said network comprising a home or a visited access network discovery and selection function, said process comprising reception at the user endpoint UE of information and policies for discovery and usage of a local access network discovery and selection function L-ANDSF.

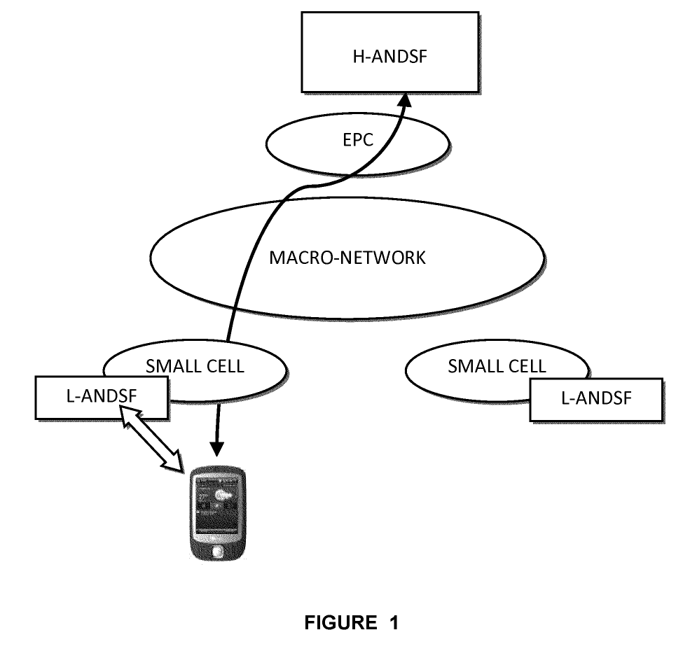

The invention generally relates to communication networks.

With the development and the deployment of various access technologies, the mobile communication system is evolving towards a dense wireless environment where multiple access networks highly overlap and complement each other in terms of total available throughput, transmission delay and operational costs.

Network architectures have to consider the increase in number of subscribers and their highly diversified resource requirements and to select the momentary best access networks for the most efficient delivery of the applications including the preferences from the user, the core network and the service provider.

This mechanism, named access network selection mechanism, presumes that one access network is selected for the communication of the mobile device by either the network or the mobile device itself and that a handover to the selected access network is executed in order to obtain a dynamic best connection according to the momentary characteristics of the access network and to the momentary requirements of the mobile device.

Complementing the selection, an Access Network Discovery Mechanism (ANDM) is required which determines the access networks located in the vicinity of the mobile device, thus available to be selected and gives policies to control the selection mechanism. The currently deployed ANDM presumes that (in case of selection not involving only 3gpp based radio) the mobile device decides independently the access through which it communicates using local configuration and semi-static configuration received from the network (e.g. from the ANDSF defined in 3gpp Release 8/9/10/11 specifications). However, the mobile device is not aware of the momentary context in the network, therefore this mechanism does not offer guarantees that the selected access is able to sustain the communication with the appropriate quality and at a satisfying operational cost.

Also for the discovery mechanism, the current solution relies on multiple scans of the wireless environment a power consuming operation which has to be executed by the mobile device for the discovery of available accesses.

To fulfil the requirements of the operators for the heterogeneous wireless broadband environment, the 3^{rd} Generation Partnership Project (3GPP) initiated the standardization process for the Evolved Packet Core (EPC) as an all-IP based multi-access core network which integrates wireless technologies standardized by 3GPP—i.e. LTE, LTE-A, UMTS, GPRS—and outside-3GPP—i.e. cdma2000, WiFi, WiMAX etc.

Recognizing the need for the integration into a converged wireless environment of 3GPP and non-3GPP access technologies, 3GPP initiated the standardization of the EPC as an all-IP architecture which is able to support access control, subscription based resource reservations, security and seamless mobility between the different access networks.

However, for the interconnection with or between the other non-3GPP access technologies (e.g. WiMAX, WiFi), the network discovery and selection mechanism does not rely on access network specific functionality due to separate standardization groups defining the 3gpp based radio and the non 3gpp based radio. Especially there is no inter Radio Access Network communication between a 3GPP radio and a non 3gpp Radio (each being ignorant of the existence of the other). Because of this, the network discovery and selection functionality was introduced on top of the EPC architecture as an enabler.

It assumes that two functional entities are deployed, one in the Network—denominated as Access Network Discovery and Selection Function (ANDSF) and one in the user endpoint.

The user endpoint UE is able to receive discovery information and selection policies from the ANDSF using a logical interface. On this interface, Open Mobile Alliance Device Management (OMA-DM) protocol is deployed, which supports dynamic updating mechanisms.

A Management Object (MO) for the network discovery and selection functionality was specified by 3GPP. The MO describes the information exchanged between the UE and the ANDSF and contains the discovery information for the different access networks and the inter-system handover policies which enable the mobile device to execute the access network selection according to the requirements of the network provider. For multi-access capable mobile devices, the MO was extended to include information on the device interfaces that can be used for the different data flows. The UE transmits to the ANDSF the momentary location as geo-location or as information on the accesses to which it is currently connected to. For example, for a UE connected to an LTE access network, the location information may contain apart from the geo-location, the operator domain, the Tracking Area Code and the cell identification. Each of these pieces of information can localize the mobile device in the environment with a certain level of granularity.

The ANDSF responds to the UE with a set of policies (such as “Inter-System Mobility Policies” or “ISMP” and “Inter-System Routing Policies” or “ISRP”) separated for different physical areas which contain information on the access networks (e.g. for WiFi the SSID and the HESSID), on criteria (e.g. target IP address of an IP packet) to select an access network for sending IP traffic, on validity condition (time, location) for the policy and on a prioritization between the policies and Access Networks. This information enables the UE to select the target access network restricted to a specific location and time interval, ordered by the operator preference.

The ANDSF maintains a Coverage Map database, which contains static information on the accesses available based on the location.

Although this solution provides the operators with a minimal mechanism for access network discovery and selection control, the information transmitted from the ANDSF to the UE does not state any information on the availability of the resources that are required for a seamless communication. Also, the information is static. The UE does not have any guarantee that the access networks received are available in the area. For example, a WiFi access network may be available in the vicinity of the UE, but because of various external factors such as radio interference, environmental conditions, operational failure etc, it may not sustain the communication.

The access network discovery and selection function ANDSF as currently standardized by 3GPP thus enables the network operator with a minimal operational cost to minimally control over the access networks through which the mobile device communicates.

The ANDSF specified by 3GPP provides discovery information about available non-3GPP access networks as well as operator policies regarding the use of those non-3GPP access networks. Two types of ANDSF are defined: Home-ANDSF (H-ANDSF) for policies and discovery information from the home network operator and Visited-ANDSF (V-ANDSF) for the roaming case. In both cases an ANDSF server would provide semi-static information over a wide area. When the non-3GPP access is based on small cells (WiFi access points) then it is virtually impossible to take into account dynamic local conditions for an update of the policy as these can change very fast based on interferences and number of users. Furthermore such updates would only be meaningful to a very small number of UE, i.e. those located under the coverage or nearby the access point.

It is an object of embodiments of the invention to offer the operator a mean of providing local and real time related updates of policies to UE.

It is another object of embodiments of the invention to offer the operator a mean of providing local and real time related updates of policies to the UE while re-using existing mechanisms from the UE point of view.

Embodiments of the invention provide a communication process within a network such as a Wi-Fi network, said network comprising a home or a visited access network discovery and selection function, said process comprising reception at the user endpoint UE of information and policies for discovery and usage of a local access network discovery and selection function L-ANDSF, said policies being received from the home or a visited access network discovery and selection function.

The communication process presents the following features, according to various embodiments:
said information include authorization information and/or addressing information and/or hysteresis information and/or possibly protocol information,
said authorization information indicates to the UE conditions allowing usage of said L-ANDSF,
said addressing information indicates to the UE how to find at least one L-ANDSF,
said hysteresis information gives limits to the time where the L-ANDSF policy takes precedence over home or visited ANDSF policy,
said protocol information provided by the ANDSF indicates which protocols to use to reach the L-ANDSF,
said addressing information provided by the ANDSF indicates that the actual addressing and protocol to access to the L-ANDSF are provided using local layer 2 or radio signaling such as extensions to 802.11 u.

Embodiments of the invention also provide a home or visited access network discovery and selection function ANDSF, a local access network discovery and selection function L-ANDSF, and a user endpoint UE, the user endpoint UE receiving information and policies for discovery and usage of the local access network discovery and selection function L-ANDSF, said policies being received from the home or visited access network discovery and selection function ANDSF.

According to various embodiments, possibly combined:
said information include authorization information and/or addressing information and/or hysteresis information and/or possibly protocol information,
said authorization information indicates to the UE conditions allowing usage of said L-ANDSF,
said addressing information indicates to the UE how to find at least one L-ANDSF,
said hysteresis information gives limits to the time where the L-ANDSF policy takes precedence over home or visited ANDSF policy,
said protocol information provided by the ANDSF indicates which protocols to use to reach the L-ANDSF,
said addressing information provided by the ANDSF indicates that the actual addressing and protocol to access to the L-ANDSF are provided using local layer 2 or radio signaling such as extensions to 802.11 u.

Embodiments of the invention also provide a communication network comprising an access network discovery and selection function ANDSF and a local access network discovery and selection function L-ANDSF, the user endpoint UE receiving from the ANDSF information and policies for discovery and usage of said L-ANDSF, said information including authorization information and/or addressing information and/or hysteresis information and/or possibly protocol information.

According to various embodiments, the communication network presents some of the following features, possibly combined:
the L-ANDSF is located within a hotspot access point or controller or within a femto cell or within a DSL box;
the ANDSF provides the public IP address or FQDN of the L-ANDSF,
the ANDSF provides information to look for 802.11u advertised L-ANDSF address or policies;
the ANDSF may provide information on the protocol to be used with the L-ANDSF (OMA-DM based ANDSF MO or IEEE 802.21 or IEEE 802.11v);
alternatively, when 802.11u is referred to by the ANDSF as the way to reach the L-ANDSF, 802.11u based signaling may provide information on the actual protocol to be used to reach the L-ANDSF
the ANDSF may provide information on ANQP queries that may be performed prior to attachment, these may include WAN metrics as defined by the Hotspot2.0 initiative and potential thresholds for selection;
the ANDSF provides policy to prefer WLAN with the SSID of the hotspot and usage authorization in the location where the hotspot is available;
the ANDSF provides hysteresis indicating that after an inter RAT handover from non 3GPP to 3GPP access, the UE should not switch again based on ANDSF policies for the duration of the hysteresis;
the ANDSF provides semi-static policies to control UE selection of where to camp such as inter-system mobility policies ISMP and/or inter-system routing policies ISRP.

Embodiments of the invention also provide an access network discovery and selection function ANDSF, a local access network discovery and selection function L-ANDSF, and a user endpoint UE, the user endpoint UE receiving from the ANDSF information and policies for discovery and usage of said L-ANDSF, said information including authorization information and/or addressing information and/or hysteresis information and/or possibly protocol information.

According to various embodiments, eventually combined:
the L-ANDSF is located within a hotspot access point or controller or within a femto cell or within a DSL box;
the ANDSF provides the public IP address or FQDN of the L-ANDSF;
the ANDSF provides information to look for 802.11u advertised L-ANDSF address or policies;
the ANDSF may provide information on the protocol to be used with the L-ANDSF (OMA-DM based ANDSF MO or IEEE 802.21 or IEEE 802.11v);
alternatively, when 802.11u is referred to by the ANDSF as the way to reach the L-ANDSF, 802.11u based signaling may provide information on the actual protocol to be used to reach the L-ANDSF
the ANDSF may provide information on ANQP queries that may be performed prior to attachment, these may include WAN metrics as defined by the Hotspot2.0 initiative and potential thresholds for selection;
the ANDSF provides policy to prefer WLAN with the SSID of the hotspot and usage authorization in the location where the hotspot is available;
the ANDSF provides hysteresis indicating that after an inter RAT handover from non 3GPP to 3GPP access, the UE should not switch again based on ANDSF policies for the duration of the hysteresis;
the ANDSF provides semi-static policies to control UE selection of where to camp such as inter-system mobility policies ISMP and/or inter-system routing policies ISRP.

Embodiments of the present invention are directed to addressing the effects of one or more of the problems set forth above. The following presents a simplified summary of embodiments of the invention in order to provide a basic understanding of some aspects of embodiments of the invention. This summary is not an exhaustive overview of the invention. It is not intended to identify key critical elements of the invention or to delineate the scope of the invention. Its sole purpose is to present some concepts in a simplified form as a prelude to the more detailed description that is discussed later.

While embodiments of the invention are susceptible to various modification and alternative forms, specific embodiments thereof have been shown by way of example in the drawings. It should be understood, however, that the description herein of specific embodiments is not intended to limit the invention to the particular forms disclosed.

It may of course be appreciated that in the development of any such actual embodiments, implementation-specific decisions should be made to achieve the developer's specific goal, such as compliance with system-related and business-related constraints. It will be appreciated that such a development effort might be time consuming but may nevertheless be a routine understanding for those or ordinary skill in the art having the benefit of this disclosure.

The objects, advantages and other features of embodiments of the present invention will become more apparent from the following disclosure and claims. The following non-restrictive description of preferred embodiments is given for the purpose of exemplification only with reference to the accompanying drawing.

In the following description ANDSF will refer to the currently 3GPP-defined H-ANDSF or V-ANDSF as opposed to the local-ANDSF (L-ANDSF) that can be co-located with an access point or a home Node B/eNB or an aggregation gateway, or an access point controller equipment.

This L-ANDSF function provides discovery information that could not have been available at the H-ANDSF level (for instance if a H(e)NB also supports a wifi interface, information regarding this Wireless Local Area Network WLAN) and Inter-System Mobility Policies ISMP (as well as Inter-System Routing Policies ISRP) that take into account local real-time conditions (e.g. load, number of users) as well as semi-static information like some services reachability.

As the L-ANDSF is a local resource, traffic between the UE and the L-ANDSF does advantageously not need to be sent via the EPC.

To communicate with the UE the L-ANDSF uses either the OMA-DM based ANDSF protocol or the IEEE 802.21 Media Independent Handover MIH protocol or IEEE 802.11v BSS transition mechanisms or Hotspot2.0 defined ANQP queries or an extension of those queries or a combination of those mechanisms such as the following: the syntax to transfer information per the ANDSF OMA DM Management Object semantic but the protocol to carry the information based on additions to 802.11u ANQP.

The ANDSF model defined in 3GPP TS 24.312 provides the UE with instructions/policies of the operator (received from the ANDSF) regarding usage of an L-ANDSF function.

The additional information added in the ANDSF model is of following types: authorization, addressing, protocol, hysteresis to avoid too frequent inter-RAT handovers.

The authorization information is provided by the ANDSF of the local PLMN to UE and indicates to the UE whether usage of an L-ANDSF is allowed within a certain validity condition (e.g. place and time). When the validity conditions are met local policies provided by the L-ANDSF may override the usual ANDSF policies for the time specified in the hysteresis information.

The authorization information also includes actions that are allowed to be performed by the L-ANDSF for example: performing load-balancing between access points inside a same access network or barring the UE from the current access (or downgrading the priority of this current access). The current access is the one on which the UE is getting access to the L-ANDSF and may e.g. correspond to the local ESSID or the local BSSID (MAC @ of the Access Point AP).

The addressing information indicates to the UE how it will find the L-ANDSF if one is available and allowed. As an example, the addressing information corresponds to the Fully Qualified Domain Name FQDN or IP @ of the L-ANDSF. According to another example, addressing information corresponds to an indication on how this FQDN or IP @ may be fetched by the UE (e.g. via 802.11u) or on whether the address and protocol to be used to reach the L-ANDSF can be directly accessed by layer 2 means (for instance if communication with the L-ANDSF is based on 802.21 or extensions to 802.11u or ANQP protocol).

The protocol information may be provided by the ANDSF or by extensions of 802.11u signaling (sent by the local WLAN) for those cases where the L-ANDSF implementation follows other standard protocols. Example of other protocols that can provide ANDSF-type information are IEEE 802.21, IEEE 802.11v, 802.11u ANQP extensions defined by or based on the Hotspot2.0 specification.

The Hysteresis information is provided by the ANDSF and allows avoiding ping-pong effect of conflicting rules sent by the ANDSF and the L-ANDSF: hysteresis information give limits to the time where the L-ANDSF policy takes precedence over the global ANDSF policy.

According to one embodiment, corresponding to Wi-Fi offload in operator hotspots, a mobile operator that also owns Wi-Fi hotspots (or has a partnership with another operator) adds an L-ANDSF function co-located with the hotspot access controller that is advertised per 802.11u. In addition to providing via the ANDSF a policy to prefer WLAN with the Service Set Identifier SSID of the hotspot in the location where such a hotspot is available, the ANDSF provides:
L-ANDSF usage authorization in the location where the hotspot is available. This allows the L-ANDSF to bar the UE from the hotspot during the hysteresis time
   downgrading the priority for the local ESSID
   downgrading the priority for a BSSID (MAC @ of the AP)
      way (e.g. 802.11u) to access the L-ANDSF address;
      hysteresis indicating that after an inter-radio access technology (RAT) handover from non-3GPP to 3GPP access, the UE should not switch RATs again based on ANDSF policies for the duration of the hysteresis (e.g. 20 minutes).

A UE contacts the ANDSF and receives all the information above (meaning the current standard discovery information plus ANDSF policies such as ISMP and ISRP). When arriving in the validity area (in time and space) of the Wi-Fi hotspot, it chooses to connect to the Wi-Fi network based on the policies received from the ANDSF. Once connected to the hotspot, it accesses the L-ANDSF fetching first over 802.11u the addressing and protocol to use to reach the L-ANDSF. If congestion occurs or the hotspot controller detects that it is no longer desirable to keep this UE on the Wi-Fi network (for instance by monitoring retransmissions errors), it sends a policy to move back to the cellular network. The hysteresis information previously received will ensure that the UE does not attempt to move back to the Wi-Fi network until the allocated time has elapsed.

According to another embodiment, corresponding to Wi-Fi offload in residential networks, a mobile operator that is also an ISP wishes to offload data traffic on the residential access points of his subscribers. Thus it equips its DSL boxes with an L-ANDSF. When connected on the macro cellular network, the UE receives the following information from the ANDSF:
policy to prefer WLAN in the location of the subscriber home cell plus:
   local-ANDSF usage authorization in that home cell (this authorization only allows steering from Wi-Fi to 3G)
   public IP address (or FQDN) of the L-ANDSF hysteresis indicating that after an inter-RAT handover from non-3GPP to 3GPP access, the UE should not switch RATs again based on ANDSF policies for instance 20 minutes time.

A UE contacts the ANDSF and receives all the information above (meaning the current standard discovery information plus ANDSF policies such as ISMP and ISRP). When arriving at home, it chooses to connect to the Wi-Fi network based on the policies received from the ANDSF. Once connected to the access point, it accesses the L-ANDSF using the address received from ANDSF. If for instance the DSL line gets congested due to the traffic of several home users, the L-ANDSF may send a policy to the UE to migrate back to 3G. The hysteresis information previously received will ensure that the UE does not attempt to move back to the Wi-Fi network until the allocated time has elapsed.

According to another embodiment, corresponding to Wi-Fi offload in operator hotspots, a mobile operator that also owns Wi-Fi hotspots (or has a partnership with another operator) adds an L-ANDSF function co-located with the hotspot access controller. In addition to providing via the ANDSF a policy to prefer WLAN with the Service Set Identifier SSID of the hotspot in the location where such a hotspot is available, the ANDSF provides:
L-ANDSF usage authorization in the location where the hotspot is available. This allows the L-ANDSF to bar the UE from the hotspot during the hysteresis time
   downgrading the priority for a BSSID (MAC @ of the AP)
protocol to be used for L-ANDSF (for instance IEEE 802.11v).

A UE contacts the ANDSF and receives all the information above (meaning the current standard discovery information plus ANDSF policies such as ISMP and ISRP). When arriving in the validity area (in time and space) of the Wi-Fi hotspot, it chooses to connect to the Wi-Fi network based on the policies received from the ANDSF. Once connected to the hotspot, it uses 802.11v BSS transition management feature for choosing the best access point in the hotspot. If congestion occurs, the L-ANDSF will send a BSS transition management query with a preferred BSS list or barring certain BSSIDs.

According to another embodiment, corresponding to Wi-Fi offload in enterprise networks, an enterprise network is setup using femto cells. The femto base stations also have a co-located Wi-Fi access point ability. A Local-ANDSF function is co-located with the femto cell. Possibly due to different generations of equipment, that enterprise network is also including femto base stations without Wi-Fi ability. Those femto also do not have an L-ANDSF. The operator H-ANDSF cannot keep track of which cells can provide Wi-Fi service in the enterprise network and which cannot. The L-ANDSF function provides discovery information that could not have been available at the H-ANDSF level.

The policies provided by an L-ANDSF using OAM-DM based ANDSF could be both ISMP and ISRP. An example of use with ISRP could be that for a VoIP or video streaming application for which usually operators prefer to use QoS-aware networks, if locally the monitoring shows that the right QoS conditions can be met (e.g. no interference, sole user) then the ISRP provided by the L-ANDSF could suggest to move a VoIP or video streaming flow to the wifi interface.

Embodiments of the present invention allow offering an ANDSF solution that takes into account dynamic conditions on the Wi-Fi networks. Embodiments of the present invention allow adapting Wi-Fi offloads to local dynamic conditions under the full control of the operator.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. Communication process within a network, said network comprising a home or a visited access network discovery and selection function, said process comprising reception at the user endpoint UE of information and policies for discovery and usage of a local access network discovery and selection function L-ANDSF, said policies being received from the home or a visited access network discovery and selection function.

2. Communication process according to claim 1, wherein said information includes authorization information and/or addressing information and/or protocol information and/or hysteresis information.

3. Communication process according to claim 2, wherein said authorization information indicates to the UE conditions allowing usage of said L-ANDSF.

4. Communication process according to claim 2, wherein said addressing information indicates to the UE how to find at least one L-ANDSF.

5. Communication process according to claim 2, wherein said hysteresis information gives limits to the time where the L-ANDSF policy takes precedence over home or visited ANDSF policy.

6. Communication process according to claim 2, wherein said protocol information provided by the ANDSF indicates which protocols to use to reach the L-ANDSF.

7. Communication process according to claim 2, wherein said addressing information provided by the ANDSF indicates that the actual addressing and protocol to access to the L-ANDSF are provided using local layer 2 or radio signaling such as extensions to 802.11 u.

8. Communication network comprising an access network discovery and selection function ANDSF and a local access network discovery and selection function L-ANDSF, the user endpoint UE receiving from the ANDSF information and policies for discovery and usage of said L-ANDSF, said information including authorization information and/or addressing information and/or protocol information and/or hysteresis information.

9. Communication network according to claim 8 wherein the L-ANDSF is located with a hotspot access controller or with a femto cell or with a DSL box or with an access point or with an aggregation gateway.

10. Communication network according to claim 8, wherein the ANDSF provides public IP address or FQDN of the L-ANDSF.

11. Communication network according to claim 8, wherein the ANDSF provides information to look for 802.11u advertised L-ANDSF.

12. Communication network according to claim 8, wherein the ANDSF provides information for use of 802.21 or 802.11v.

13. Communication network according to claim 8, wherein the ANDSF provides information for use of extensions of ANQP queries as defined by the Hotspot2.0 specification.

14. Communication network according to claim 8, wherein the ANDSF provides policy to prefer WLAN with the SSID of the hotspot and usage authorization in the location where the hotspot is available.

15. Communication network according to claim 8, wherein the ANDSF provides hysteresis indicating that after an inter RAT handover from non 3GPP to 3GPP access, the UE should not switch again based on ANDSF policies for the duration of the hysteresis.

16. Communication network according to claims 8, wherein the L-ANDSF provides discovery information, inter-system mobility policies ISMP and/or inter-system routing policies ISRP.

17. Access network discovery and selection function ANDSF, providing to an user endpoint UE information and policies for discovery and usage of a local access network discovery and selection function L-ANDSF, said information including authorization information and/or addressing information and/or hysteresis information and/or possibly protocol information.

18. User endpoint UE receiving from an access network discovery and selection function ANDSF information and policies for discovery and usage of a local access network discovery and selection function L-ANDSF, said information including authorization information and/or addressing information and/or hysteresis information and/or possibly protocol information.

19. Access network discovery and selection function ANDSF, providing information for use of extensions of ANQP queries as defined by the Hotspot2.0 specification.
